(19) United States
(12) Patent Application Publication
(10) Pub. No.: US 2024/0299920 A1
(43) Pub. Date: Sep. 12, 2024

(54) HETEROGENEOUS CATALYSTS

(71) Applicant: North Carolina State University, Raleigh, NC (US)

(72) Inventors: Wei Gao, Apex, NC (US); Nanfei He, Raleigh, NC (US); Ki Hong, Raleigh, NC (US); Richard Kotek, Raleigh, NC (US); Shradha V. Patil, Smyrna, GA (US)

(21) Appl. No.: 18/549,219

(22) PCT Filed: Mar. 8, 2022
(86) PCT No.: PCT/US2022/019247

§ 371 Date: Sep. 6, 2023

Related U.S. Application Data
(60) Provisional application No. 63/158,009, filed on Mar. 8, 2021.

(51) Int. Cl. B01J 31/12; B01J 35/61; B01J 37/02

(52) U.S. Cl. CPC B01J 31/122; B01J 35/612; B01J 37/0203; B01J 37/0209

(57) ABSTRACT

Exemplary catalysts may comprise a two-dimensional substrate and at least one organometallic compound bonded to the two-dimensional substrate. The at least one organometallic compound may comprise a carbonyl group. Exemplary methods of preparing a polymer product may comprise combining a catalyst with an alcohol and an ester in a solvent, thereby generating a mixture, and obtaining the polymer product from the mixture.

### CROSS-REFERENCE TO RELATED APPLICATION(S)

The present application is related to and claims the priority benefit of U.S. Provisional Patent Application No. 63/158,009, filed on Mar. 8, 2021, the entire contents of which are incorporated herein by reference.

### TECHNICAL FIELD

The present disclosure relates to heterogeneous catalysts. More specifically, materials and methods disclosed and contemplated herein relate to generation and use of heterogeneous catalysts and are particularly suitable for polymerization reactions such as transesterification.

### INTRODUCTION

Existing techniques for generating polymer products can utilize homogeneous catalysts. For instance, one or more transesterification reaction may involve combination of a homogenous catalyst with polymer precursor ingredients. However, when using these techniques, the homogeneous catalyst is not separable from the reaction products. Retention of catalyst with the polymer product can have various undesirable detrimental effects on the polymer product.

### SUMMARY

In one aspect, a catalyst is disclosed. An exemplary catalyst may comprise a two-dimensional substrate and at least one organometallic compound bonded to the two-dimensional substrate. The at least one organometallic compound may comprise a carbonyl group.

In another aspect, a method of preparing a polymer product is disclosed. An exemplary method may comprise combining a catalyst with an alcohol and an ester in a solvent, thereby generating a mixture, and obtaining the polymer product from the mixture. The catalyst may comprise a two-dimensional substrate and organometallic compounds, where each organometallic compound may comprise a carbonyl group and is bonded to the two-dimensional substrate.

In another aspect, a method of making a catalyst is disclosed. An exemplary method may comprise combining a two-dimensional substrate, a first organic solvent, and a deprotonation reagent to form a mixture, adding an organometallic compound to the mixture, reacting the mixture with the organometallic compound for a predetermined period of time, combining the mixture and a second organic solvent, and filtering the mixture with the second organic solvent.

There is no specific requirement that a material, technique or method relating to heterogeneous catalysts include all of the details characterized herein to obtain some benefit according to the present disclosure. Thus, the specific examples characterized herein are meant to be exemplary applications of the techniques described, and alternatives are possible.

### BRIEF DESCRIPTION OF THF DRAWINGS

FIG. 1 is a schematic depiction of an exemplary catalyst, where dibutyltin oxide is chemically grafted onto individual GO surfaces.

FIG. 2 shows representative reaction schemes for a GO-Sn synthesis route (top) and a MXene-Sn synthesis route (bottom).

FIG. 3 shows Fourier-transform infrared spectroscopy (FTIR) spectra comparison between the pristine GO and GO-Sn (dark).

FIG. 4A is an SEM image of pristine GO surface, featured with thin, random wrinkles and creases. FIG. 4B is an SEM image of GO-Sn surfaces, with large chunky structures emerging due to the grafting of Sn-containing species. FIG. 4C is an SEM image of GO-Sn surfaces, with large chunky structures emerging due to the grafting of Sn-containing species.

FIG. 4D shows EDX analysis of the zoomed-in area as highlighted in the green box in FIG. 4C, with elemental Sn signal estimated to be 35.2 wt. %.

FIG. 5A shows thermogravimetric analysis (TGA) curves of GO (lighter) and GO-Sn (darker) obtained in air, with a ramping rate of 2° C./min. At 800° C., ca. 42 wt. % remained for GO-Sn, while GO sample was completely burned off. FIG. 5B shows a photographic image of two DMT/TMCD reaction mixtures taken at different stages of the reaction, with GO-Sn catalyst particles shown in dark. FIG. 5C shows a table listing the Inductive Coupled Plasma Mass Spectrometry (ICP-MS) data of elemental Sn concentration in the reaction mixture.

FIG. 6A shows TGA curves of pristine GO, pristine dibutyltin oxide, GO-Sn, MXene, and MXene-GO samples. FIG. 6B shows differential scanning calorimetry (DSC) curves of pristine GO, pristine dibutyltin oxide, GO-Sn, MXene, and MXene-GO samples.

FIG. 7A shows XPS spectra of GO and GO-Sn catalysts. FIG. 7B shows XPS spectra of MXene and MXene-Sn catalysts.

FIG. 8A and FIG. 8B show NMR spectra of reaction products without methanol and with methanol, respectively as an initial solvent.

FIG. 9A and FIG. 9B present the percent conversion data at different time intervals and Sn loadings.

FIG. 10A and FIG. 10B show catalytic behavior of GO-Sn catalyst in exemplar transesterification reactions (DMT:TMCD=1:2, molar ratio) at different reaction temperatures.

FIG. 11 shows SEM images of GO-Sn catalyst samples separated from different treatments: a) as-prepared, b) washed with acetone, c) washed with methanol, d) mixed with DMT-TMCD at room temperature, e) reacted with DMT-TMCD at 230° C. for one hour, and f) reacted with DMT-TMCD at 230° C. for three hours. Scale bars: 5 μm.

FIG. 12a, b and c show DMT percent conversion versus time curves (reaction kinetics) from GO-Sn recycled with different solvents: (a) acetone, (b) chloroform, and (c) THF. FIG. 12d shows a modified chemical structure model for the experimental GO-Sn catalyst.

### DETAILED DESCRIPTION

Systems and methods disclosed and contemplated herein relate to heterogeneous catalysts that are suitable for polymerization reactions. Broadly, exemplary catalysts may comprise a two-dimensional substrate and at least one organometallic compound bonded to the two-dimensional substrate. In exemplary implementations, heterogeneous catalysts may be generated via chemical grafting of at least one organometallic compound to a two-dimensional substrate. Exemplary heterogeneous catalysts may be used during transesterification reactions, separated, and retain partial catalytic activity. Use of a separable heterogenous catalyst may improve the long-term stability of resulting polymer products, for instance, against various environmental factors such as sunlight or thermal exposure.

### I. DEFINITIONS

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifiers “about” or “approximately” used in connection with a quantity are inclusive of the stated value and has the meaning dictated by the context (for example, it includes at least the degree of error associated with the measurement of the particular quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. EXAMPLE CATALYSTS

Example catalysts disclosed and contemplated herein include a two-dimensional substrate and at least one organometallic compound bonded to the two-dimensional substrate. Various aspects of exemplary catalysts are discussed below.

### A. Exemplary Chemical Constituents

As discussed above, exemplary catalysts include a two-dimensional substrate. Two-dimensional substrates are crystalline materials that typically have thicknesses of a few nanometers or less. In some instances, two-dimensional substrates comprise a single layer or only a few layers of atoms. The two-dimensional substrate may comprise graphene oxide.

Generally, “graphene” refers to one atomic layer of graphite, where sp² carbon atoms are arranged in honeycomb structure. Upon chemical oxidation of graphite powder, oxidized graphene (termed “graphene oxide,” abbreviated as GO) can be synthesized in aqueous dispersions, with about two thirds of the carbon atoms oxidized into various oxygenated moieties. Upon dispersion of GO in a solvent, these moieties tend to be partially charged, spontaneously exfoliating GO sheets into individual layers, providing large surface area and high reactivity for potential chemical reactions.

Exemplary catalysts also include one or more organometallic compounds. Organometallic compounds are chemical compounds including at least one chemical bond between a carbon atom of an organic group and a metal. Typically, example organometallic compounds comprise one or more carbonyl groups. In some instances, example organometallic compounds comprise one or more organotin compounds. In some instances, exemplary organometallic compounds may comprise dibutyltin oxide (Sn(C₄H₉)₂O). In some instances, exemplary organometallic compounds may comprise dibutyltin dioctoate, dibutyltin dioleylmaleate, dibutyltin dibutylmaleate, dibutyltin dilaurate, 1,1,3,3-tetrabutyl-1,3-dilauryloxycarbonyldistannoxane, dibutyltin diacetate, dibutyltin diacetylacetonate, dibutyltin bis(o-phenylphenoxide), dibutyltin oxide, dibutyltin bis(triethoxysilicate), dibutyltin distearate, dibutyltin bis(isononyl 3-mercaptopropionate), dibutyltinbis(isooctyl thioglycolate), dioctyltin oxide, dioctyltin dilaurate, dioctyltin diacetate and dioctyltin diversatate.

### B. Various Aspects of Exemplary Catalysts

Exemplary organometallic compounds are typically chemically bonded to exemplary two-dimensional substrates. In some instances, the organometallic compounds are also physically attached to and/or entrapped with the two-dimensional substrate. For example, organometallic compounds may be physically absorbed onto the two-dimensional substrate. In some instances, exemplary catalysts may include some organometallic compounds chemically bonded to the two-dimensional substrate and some organometallic compounds physically attached to the two-dimensional substrate.

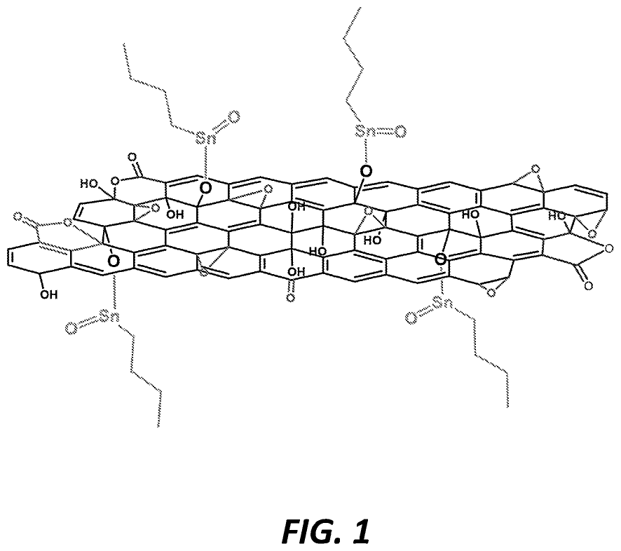

FIG. 1 is a schematic depiction of an exemplary catalyst, where dibutyltin oxide is chemically grafted onto individual GO surfaces. In actual implementations, the real stochiometry and chemical connectivity varies upon different catalyst molecules. The graphene basal plane in FIG. 1 is colored in dark, primarily comprised of an atomic-layer of sp² and sp³ carbon atoms arranged in honeycomb structure. Several oxygenated moieties exist on the surfaces and peripheries of as-prepared GO sheets, including hydroxyl, epox, ketone, ester, and lactol groups. Upon dibutyltin oxide grafting, additional tin-containing moieties have been attached onto GO surfaces.

Exemplary catalysts can have a variety of organometallic compound loadings. For instance, exemplary catalysts may comprise about 3 wt % to about 30 wt % organometallic compounds. In various implementations, exemplary catalysts may comprise at least 3 wt %; at least 7 wt %; at least 11 wt %; at least 15 wt %; at least 19 wt %; at least 23 wt %; at least 27 wt % or at least 29 wt % organometallic compounds. In various implementations, exemplary catalysts may comprise less than 30 wt %; less than 26 wt %; less than 22 wt %; less than 18 wt %; less than 14 wt %; less than 10 wt %; less than 6 wt %; or less than 4 wt % organometallic compounds. In various implementations, exemplary catalysts may comprise 3 wt % to 30 wt %; 3 wt % to 15 wt %; 15 wt % to 30 wt %; 3 wt % to 10 wt %; 10 wt % to 20 wt %; 20 wt % to 30 wt %; or 25 wt % to 30 wt % organometallic compounds.

Exemplary catalysts may have a lateral dimension that is up to about 0.5 μm to about 3 μm. In various implementations, exemplary catalysts may have a lateral dimension that is at least 0.5 μm; at least 1 μm; at least 1.5 μm; at least 2 μm; or at least 2.5 μm. In various implementations, exemplary catalysts may have a lateral dimension that is less than 3 μm; less than 2.5 μm; less than 2 μm; less than 1.5 μm; or less than 1 μm. In various implementations, exemplary catalysts may have a lateral dimension that is about 0.5 μm to about 3 μm; about 0.5 μm to about 1 μm; about 1 μm to about 2 μm; or about 2 μm to about 3 μm.

Exemplary catalysts typically may have a submicron thickness. In various implementations, exemplary catalysts may have a thickness that is at least 10 nm; at least 25 nm; at least 50 nm; at least 75 nm; at least 100 nm; at least 200 nm; or at least 300 nm. In various implementations, exemplary catalysts may have a thickness that is less than about 400 nm; less than about 300 nm; less than about 200 nm; less than about 100 nm; less than about 75 nm; less than about 50 nm; less than about 25 nm; or less than about 10 nm. In various implementations, exemplary catalysts may have a thickness that is about 10 nm to about 400 nm; about 50 nm to about 300 nm; or about 100 nm to about 200 nm.

Exemplary catalysts may have a BET surface area of about 5 m²/g to about 6 m²/g. In various instances, exemplary catalysts may have a BET surface area of 5.0 m²/g to 6.0 m²/g; 5.2 m²/g to 5.8 m²/g; 5.5 m²/g to 6.0 m²/g; or 5.6 m²/g to 5.8 m²/g. In various instances, exemplary catalysts may have a BET surface area of at least 5.0 m²/g; at least 5.2 m²/g; at least 5.4 m²/g; at least 5.6 m²/g or at least 5.8 m²/g. In various instances, exemplary catalysts may have a BET surface area less than 6.0 m²/g; less than 5.8 m²/g; less than 5.6 m²/g; less than 5.4 m²/g; or less than 5.2 m²/g.

### III. EXAMPLE METHODS OF MAKING CATALYSTS

Example methods for making exemplary catalysts disclosed and contemplated herein can include one or more operations. An example method includes combining a two-dimensional substrate with a first organic solvent in a reaction vessel. In some instances, the two-dimensional substrate is graphene oxide. An example first organic solvent is toluene.

A deprotonation reagent may be added to the reaction vessel and the reaction vessel stirred. In some implementations, the reaction vessel is purged with an inert gas before adding the deprotonation reagent. In some implementations, the reaction vessel is purged with an inert gas while stirring.

An example inert gas may comprise nitrogen (N₂). An example deprotonation reagent may comprise butylamine (C₄H₁₁N). In some instances, the reaction vessel may be heated after adding the deprotonation reagent. In some instances, the reaction vessel contents may be heated to about 60° C. and that temperature maintained for about 60 minutes.

Then an organometallic compound can be added to the reaction vessel and the mixture reacted for a predetermined period of time. In some instances, the predetermined period of time may be between 22 hours and 24 hours. In some instances, the reaction vessel may be heated during the reaction. In some instances, the reaction vessel contents may be heated to a temperature between 105° C. and 115° C., such as 110° C.

An exemplary organometallic compound typically comprises a carbonyl group. In some instances, exemplary organometallic compounds comprise organotin compounds. As an example, exemplary organometallic compounds may comprise dibutyltin oxide (Sn(C₄H₉)₂O).

Next, the reaction vessel contents may be combined with a second organic solvent. In some instances, the second organic solvent may comprise acetone. Then the combination of the second organic solvent and reaction vessel contents may be filtered. In some implementations, an exemplary method further includes washing a retentate and drying the retentate.

### IV. EXAMPLE METHODS OF MAKING POLYMER PRODUCTS

Example methods for making polymer products disclosed and contemplated herein can include one or more operations. An example method may include combining a catalyst with an alcohol and an ester in a solvent to generate a mixture. An exemplary solvent may comprise methanol.

In some instances, the mixture is heated and/or agitated for a predetermined period of time. As examples, the mixture may be heated to about 220° C. to about 250° C.; about 230° C. to about 250° C.; about 230° C. to about 240° C. In some implementations, the mixture may be heated to at least 220° C.; at least 225° C.; at least 230° C.; at least 235° C.; at least 240° C.; or at least 245° C. In various implementations, the mixture may be heated to no more than 255° C.; no more than 250° C.; no more than 245° C.; no more than 240° C.; no more than 235° C.; or no more than 230° C.

In various implementations, the mixture may be heated for about 60 minutes to about 180 minutes; 60 minutes to about 120 minutes; 90 minutes to about 180 minutes; or about 120 minutes to about 180 minutes. In various implementations, the mixture may be heated for at least about 60 minutes; at least about 90 minutes; at least about 120 minutes; at least about 150 minutes; or at least about 180 minutes. In various implementations, the mixture may be heated for no more than about 180 minutes; no more than about 150 minutes; no more than about 120 minutes; or no more than about 90 minutes.

Exemplary alcohols may be diols. For instance, exemplary alcohols may comprise 2, 2, 4, 4-tetramethyl-1,3-cyclobutanediol (TMCD), ethylene glycol, neopentyl glycol, 2-methyl-1,3-propanediol, 1, 4-cyclohexanedimenthanol, or combinations thereof. An exemplary ester is dimethyl terephthalate (DMT).

Exemplary catalysts as disclosed herein may be used, and typically comprise a two-dimensional substrate and organometallic compounds, where each organometallic compound comprises a carbonyl group and is bonded to the two-dimensional substrate. In some instances, the two-dimensional substrate comprises graphene oxide.

In some instances, the organometallic compounds comprise organotin compounds. An example organotin compound is dibutyltin oxide (Sn(C₄H₉)₂O).

After a period of time, the polymer product may be obtained from the mixture. In some implementations, some or most of the catalyst may be separated from the mixture. Exemplary methods for separating the catalyst may include membrane filtration or vacuum filtration. In some instances, separated catalyst may be reused in subsequent polymer product generating reactions.

### V. EXPERIMENTAL EXAMPLES

Experimental examples were conducted and the results are discussed below. More specifically, an experimental catalyst was synthesized and experimental catalyst was applied during polymer reactions.

### A. Experimental Catalyst

Experimental sample catalysts were generated and various properties were evaluated, as discussed below.

### 1. Sample Preparation

Experimental samples using graphene oxide and MXene as the two-dimensional substrates were prepared by methods generally including the following steps. Graphite powder, toluene, butylamine, potassium permanganate (KMnO₄), concentrated H₂SO₄ (>98%), HCl (˜37%), nitric acid (˜68%), LiF, Ti₃AlC₂, acetone, Sn(Bu)₂O, and H₂O₂ (31%) were purchased commercially in chemical grades. Graphene oxide was synthesized according to the published work (Xu, Z.; Peng, L.; Liu, Y.; Liu, Z.; Sun, H.; Gao, W.; Gao, C. Experimental Guidance to Graphene Macroscopic Wet-Spun Fibers, Continuous Papers, and Ultralightweight Aerogels. Chem. Mater. 2017, 29 (1), 319-330), except for step A(iii) of the procedure section was replaced by microwave irradiation for 90 seconds at 750 W.

Next, 0.8 gram of graphene oxide was dispersed in 40 ml of dry toluene at the concentration of 20 mg/ml in a flask. The reaction vessel, a 3-neck round-bottom flask, was sealed with septum and grease, and purged with N₂. 4 ml of butylamine (C₄H₁₁N) was added with a glass syringe as a deprotonation reagent. The mixture was heated up to 60° C., kept there for one hour and cooled down to room temperature under magnetic stirring and N₂ purging for 24 hours. Butylamine was introduced to exfoliate the graphene oxide nanosheets and catalyze the S_{N}² reaction between graphene oxide and Sn(Bu)₂O, while N₂ purging was used to eliminate moisture. After that, 0.64 g of Sn(Bu)₂O was added into the reaction vessel and the reaction mixture was kept at 110° C. for 23 hours. No N₂ purging was required in this step.

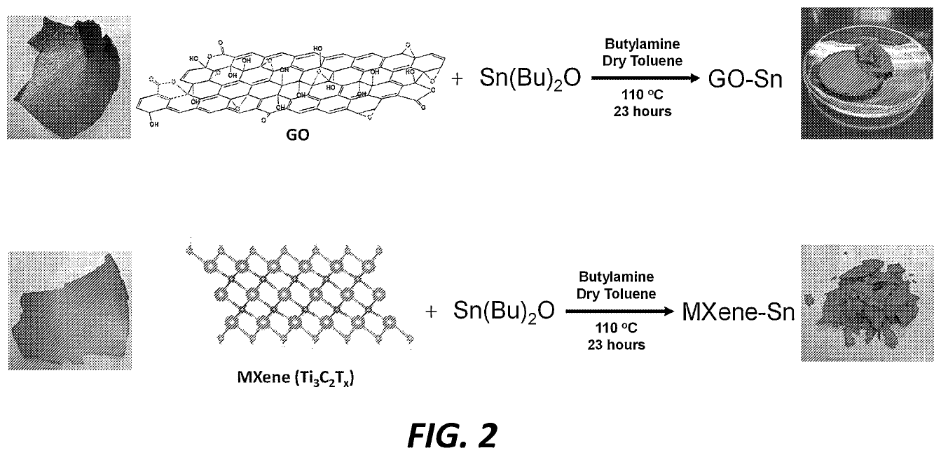

After the reaction was completed, the system was cooled down to room temperature, and acetone was poured into the flash to transfer all the reacted mixture to a vacuum filtration flask. Filtered catalyst on the filter paper (0.1 μm Omnipore™ membrane filter REF JVWP09025) was washed with acetone, water, and let dry in a fume hood for 24 hours. A representative reaction scheme with photographic images of the precursors and products are shown in FIG. 2.

The top of FIG. 2 shows a GO-Sn synthesis route and the bottom of FIG. 2 shows a MXene-Sn synthesis route. Photographic images of the 2D-material precursors and the resulted heterogenous catalysts are presented next to each chemical structure/name. Once the reactions were finished, the products were separated from the dispersions with the assistance of vacuum filtration.

### 2. Chemical Structure

Experimental samples were tested via Inductive Coupled Plasma Mass Spectrometry (ICP-MS) analysis. ICP-MS analysis was performed using a PerkinElmer ELAN DRC II (available from PerkinElmer, Waltham, Massachusetts). ICP-MS test procedures included predigesting a 0.05 g sample overnight with 3 mL of HNO₃, followed by digesting in a microwave system at 130° C. for 20 minutes and 250° C. for 20 minutes. Once cooled, the sample was diluted to 25 mL with H₂O to obtain 10% HNO₃; an aliquot of 1000 ppm scandium solution was added as an internal standard.

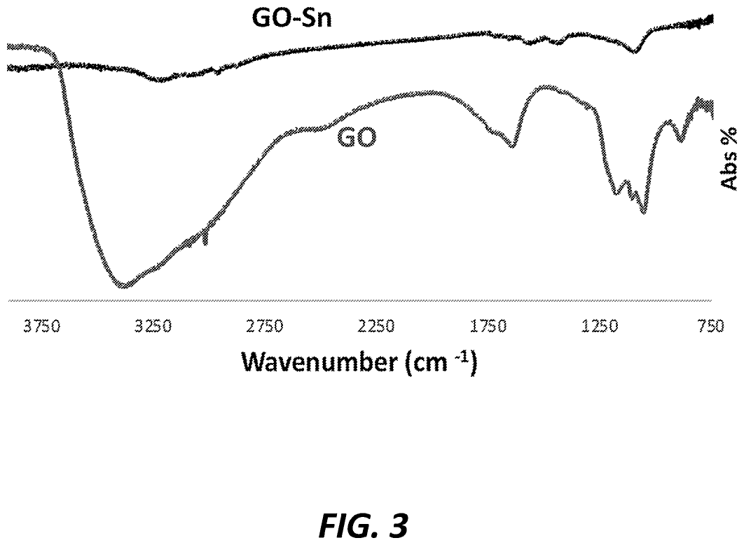

According to those tests, exemplary catalysts comprised about 27 wt % tin (Sn) loading. FIG. 3 shows Fourier-transform infrared spectroscopy (FTIR) spectra comparison between the pristine GO and GO-Sn (dark). FTIR spectroscopic analysis demonstrates the suppression of signals from oxygenated moieties and the appearance of weak signals around 2990-2850 cm¹, suggesting the partial replacement of those oxygenated groups with butyltin moieties, as shown in FIG. 3.

### 3. Microscopic Morphology

Scanning Electron Microscopy (SEM) and Energy Dispersive X-Ray (EDX) techniques were adopted here to analyze the microscopic morphology and chemical composition of the experimental catalyst. SEM images were obtained using a Verios 460L. In some instances, the SEM machine settings included magnification of 5,000×, voltage of 2.00 kV, current of 13 pA, working distance of ˜5.0 mm, and tilt of 0 degrees. EDX analysis was performed using a Verios 460L with EDX detector. In some instances, the machine settings for EDX analysis included a magnification of 5,000×, voltage of 10.00 kV, current of 1.6 nA, working distance of ˜5.2 mm, and tilt of 0 degrees.

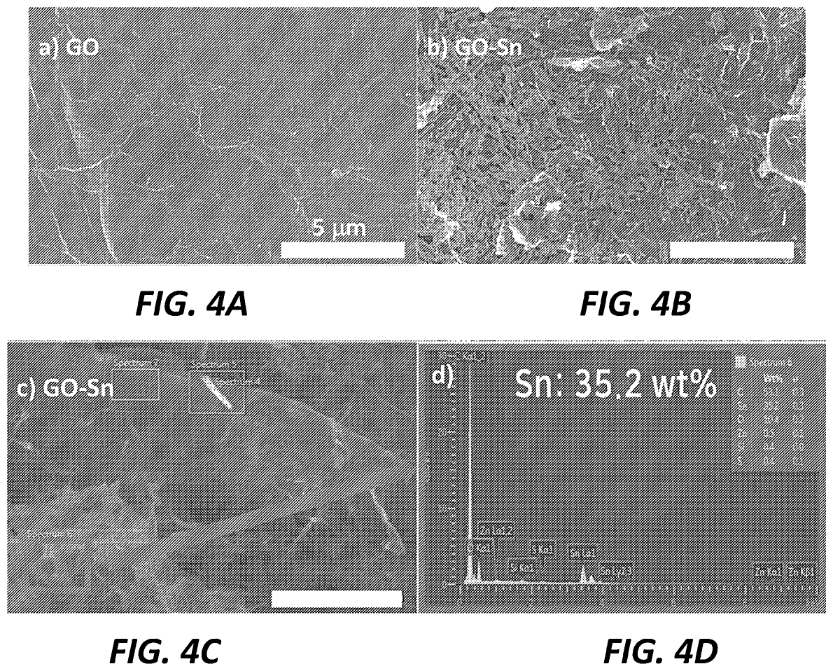

FIG. 4A is an SEM image of pristine GO surface, featured with thin, random wrinkles and creases. FIG. 4B is an SEM image of GO-Sn surfaces, with large chunky structures emerging due to the grafting of Sn-containing species. FIG. 4C is an SEM image of GO-Sn surfaces, with large chunky structures emerging due to the grafting of Sn-containing species. FIG. 4D shows EDX analysis of the zoomed-in area as highlighted in the green box in FIG. 4C, with elemental Sn signal estimated to be 35.2 wt. %.

As shown in FIG. 4A, pristine GO sheets are large 2D layers with several microns in width and only ca. 1 nm in thickness, according to the synthesis process described above. Such a high aspect ratio makes GO resembling a thin sheet of paper at nanoscale, quite flexible and easy to crease. Surprisingly, upon the grafting of Sn species, a large quantity of chunky structures appears on the GO sheet surfaces (FIG. 4B and FIG. 4C), which are Sn rich according to the EDX analysis (FIG. 4D, ca. 35 wt. %). Without being bound by a particular theory, it is hypothesized that these chunky Sn-rich structures are aggregates of the attached organotin moieties, some of which may only be physically adsorbed there.

### 4. Other Characterizations

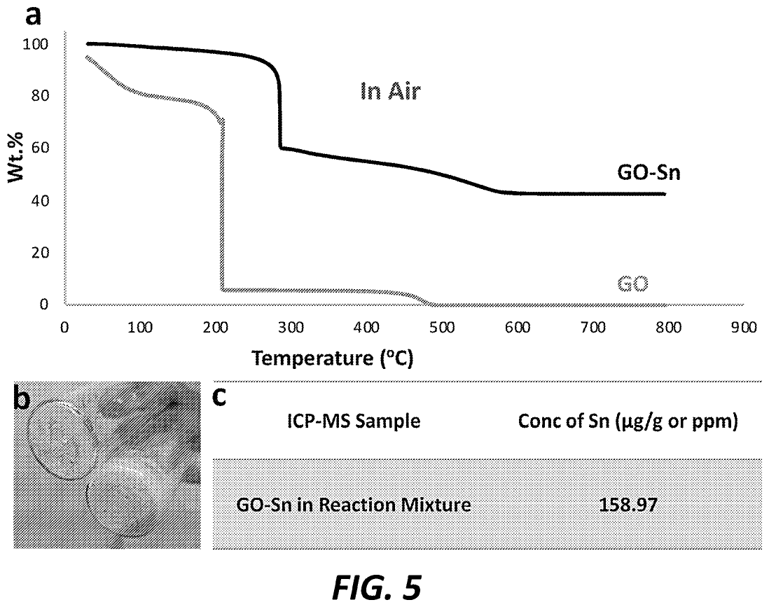

Thermogravimetric analysis (TGA) and ICP-MS data are presented in FIG. 5 to clarify the content of elemental Sn in the experimental catalyst. TGA data were obtained using a TA Instruments Q50 TGA, standard furnace. ICP-MS test procedures included predigesting a 0.05 g sample overnight with 3 mL of HNO₃, followed by digesting in a microwave system at 130° C. for 20 minutes and 250° C. for 20 minutes. Once cooled, the sample was diluted to 25 mL with H₂O to obtain 10% HNO₃; an aliquot of 1000 ppm scandium solution was added as an internal standard. ICP-MS data were obtained using a Thermo Scientific iCAP RQ ICP-MS.

FIG. 5A shows TGA curves of GO (lighter) and GO-Sn (darker) obtained in air, with a ramping rate of 2° C./min. At 800° C., ca. 42 wt. % remained for GO-Sn, while GO sample was completely burned off. FIG. 5B shows a photographic image of two DMT/TMCD reaction mixtures taken at different stages of the reaction, with GO-Sn catalyst particles shown in dark. FIG. 5C shows a table listing the ICP-MS data of elemental Sn concentration in the reaction mixture.

According to FIG. 5A, the Sn loading is estimated to be 33.4 wt. %, if the remaining mass of 42 wt. % at 800° C. of the GO-Sn curve is assigned to SnO₂. With the estimated Sn loading from TGA curve, we typically apply ca. 7.5 mg of GO-Sn in a DMT/TMCD mixture (5.0 g DMT+7.55 g TMCD) to achieve a 200 ppm of elemental Sn loading in the exemplar reactions. However, the ICP-MS data in FIG. 5C shows that the actual Sn loading in the mixture should be 158.97 ppm. We believe that the ICP-MS data is more reliable, since SnO₂ is not necessarily the chemical formula of the final solid present at the end of the TGA curve. Therefore, back calculation from the ICP-MS data (FIG. 5C) leads to an estimated Sn-loading of 26.5 wt. % in bulk GO-Sn. In comparison with the EDX data of the Sn-rich region (35.2 wt. %), this estimation appears reasonable.

Next, we will elaborate on the thermal stability of the experimental GO-Sn catalyst, while introducing another heterogeneous catalyst, MXene-Sn, which was synthesized in the early experiments for comparison purpose. MXene, a class of two-dimensional inorganic compounds based on transition metal carbide or nitrides, has also become a noted group of 2D nanomaterials in recent literature. A specific MXene sample with many hydroxyl surface moieties was chosen as an alternative to GO in the catalyst synthesis, leading to the MXene-Sn sample.

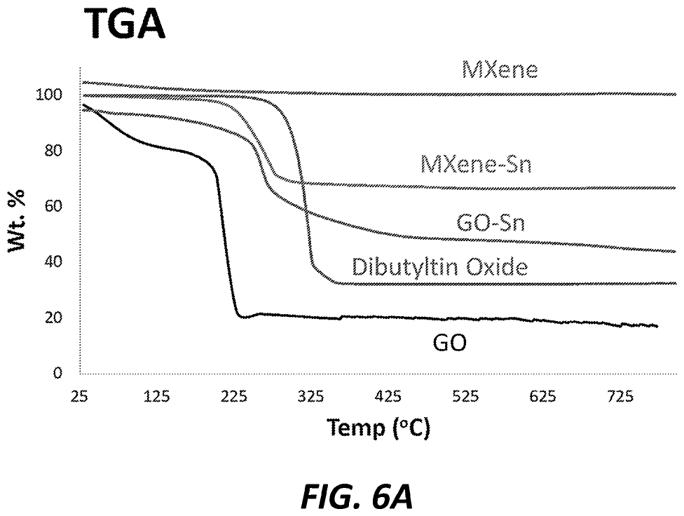

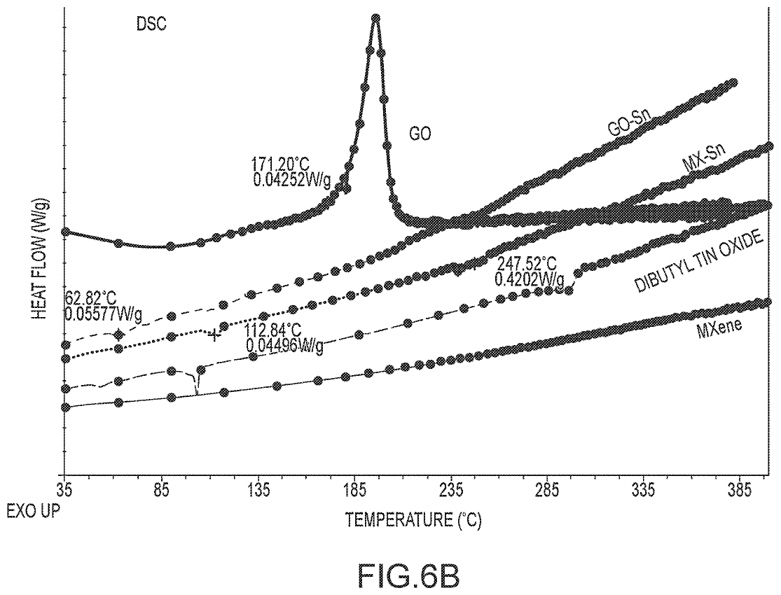

FIG. 6A shows TGA curves of pristine GO, pristine dibutyltin oxide, GO-Sn, MXene, and MXene-GO samples. FIG. 6B shows differential scanning calorimetry (DSC) curves of pristine GO, pristine dibutyltin oxide, GO-Sn, MXene, and MXene-GO samples. Because in the exemplar reaction transesterification between DMT and TMCD must run at ca. 230° C. for 2 hours minimum to achieve a good conversion, thermal stability of the experimental catalysts may be a concern. Pristine GO starts to decompose at ca. 170° C. in N₂; however, upon organotin grafting, GO-Sn catalyst does not show any major weight loss in TGA until 242° C. (FIG. 6A), making it suitable for the reaction of interest.

In addition, as heterogeneous catalysts, surface area is an important factor as well. BET surface area analysis was conducted using an Anton-Parr Quadrasorb EVO (gas sorption analyzer). During testing, N₂ was the analysis adsorptive, analysis bath temperature was −195.850° C., no thermal correction, sample mass=0.0432 g, 29.2824 cm³ measured warm free space, 87.8314 cm³ measured cold free space, equilibrium interval was 30 seconds, low pressure dose 8.0000 cm³/g STP S, sample density was 1.000 g/cm³, and no automatic degas. Pore radius and pore diameter was calculated using the BET surface area, using the equation D=4V/A, where D is average pore diameter, V is total pore volume, and A is specific surface area; for radius, the equation is R=2V/A, where R is the average pore radius. Two samples were used to calculate the average pore radius.

Table 1 lists the BET analysis results of both GO-Sn and MXene-Sn catalysts synthesized in the lab. The low BET area in both cases could be due to the severe aggregation of GO-Sn sheets in solid state; however, in the real reaction media, chemicals and solvents will be used as dispersion and exfoliation agents for catalyst particles; therefore, we would only use the reported data here for comparison purpose.

TABLE 1
BET Analysis of GO-Sn and MXene-Sn

| Properties | GO-Sn | MXene-Sn |
|---|---|---|
| BET Surface Area (m²/g) | 5.74 | 8.66 |
| Average Pore Radius (nm) | 16.64 | 8.2936 |

### 5. Further Characterizations

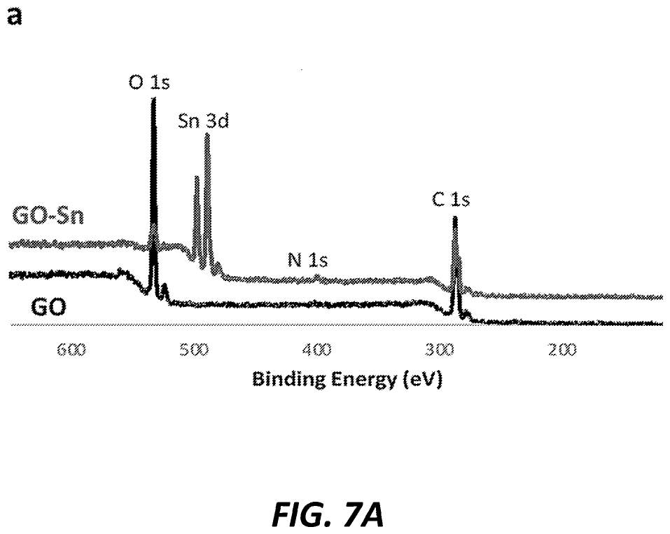

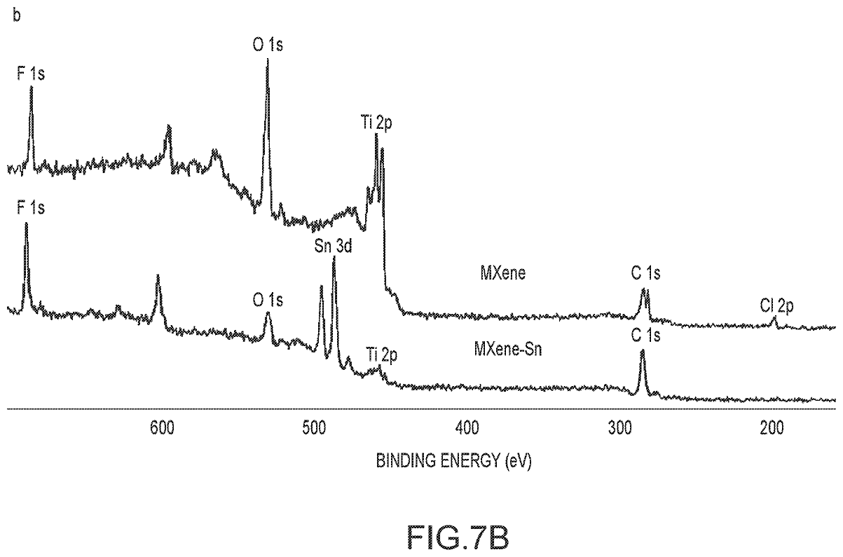

FTIR, X-ray Photoelectron Spectroscopy (XPS), SEM, EDX, TGA, DSC, Elemental Microanalysis, Time-of-flight Secondary Ion Mass Spectrometry (ToF-SIMS), dynamic light scattering (DLS), and goniometry techniques have been used to characterize exemplary heterogenous catalysts. Most of these analytical results support assertions regarding the catalyst structural features. To avoid redundancy, here we only present the XPS spectra of GO and GO-Sn in FIG. 7A, and MXene and MXene-Sn samples in FIG. 7B. A SPECS XPS Spin Resolved Photoelectron System (FlexMod) was used to obtain XPS data. The XPS sample sizes were 10 mm by 10 mm, the source was an Mg/Al dual anode, x-rays were 1.2 kV to 1.5 kV, and the data output was CasaXPS.

Elemental analysis in XPS shows that ca. 46 wt. % (8.2 at. %) of Sn was present on GO-Sn surfaces, while ca. 38 wt. % (7.6 at. %) of Sn was present on MXene-Sn surfaces. The result differs from that obtained from EDX (35.2 wt. %), TGA (33.4 wt. %), and ICP-MS (26.5 wt. %) analysis for GO-Sn; given the surface nature of XPS analysis and microscopic nature of EDX analysis, the discrepancies here are considered reasonable, with the ICP-MS data chosen as the closest to reality in bulk catalyst samples.

### B. Experimental Catalyst Applications

Experimental catalysts were applied in transesterification reactions as discussed below.

### 1. Sample Preparation

Both GO-Sn and MXene-Sn catalysts were applied in transesterification reactions between DMT and TMCD (1:2 ratio) at 5-gram scale. In a typical reaction, DMT, TMCD, GO-Sn or MXene-Sn were added into a 3 neck round-bottom flask according to the predetermined mass ratios, followed by an addition of methanol (e.g., 10-15 ml) to submerge all the reactants. A reflux condenser with a distillation receiver was connected to one of necks to collect the methanol byproduct. Then the reaction flask was flushed with N₂ and set at a pre-determined temperature (e.g., 230° C.) with a J-KEM temperature controller to let the reaction run for at least 3 hours under constant stirring.

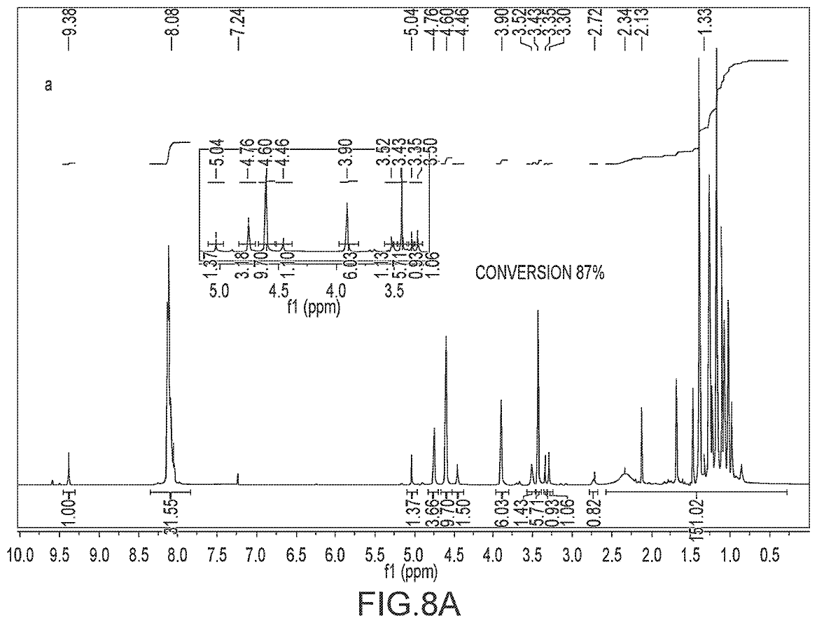

Samples for NMR tests were taken out of the flask with a preheated pipet at different time intervals and sealed in small vials after N₂ flashing. FIG. 8A and FIG. 8B show NMR spectra of reaction products without methanol and with methanol, respectively as an initial solvent. NMR spectra were obtained using a Bruker Avance NEO 600 MHz, with ¹H, CDCl₃ solvent, 256 scans, and free induction decay (FID) output.

DMT percent conversion was calculated to be 87% in FIG. 8A and 95% in FIG. 8B, according to the normalized proton signal within the chemical shift range of 3.85-3.99 ppm (methyl ester end-group protons on DMT). Methanol as an initial solvent appeared to improve conversion, as demonstrated by the NMR spectra comparison as shown in FIG. 8A and FIG. 8B. Without being bound by a particular theory, it is hypothesized that a small amount of methanol helps the thorough mixing of three primary components in the reaction vessel and partial exfoliation of the experimental heterogeneous catalyst, which can facilitate heterogenous catalysis.

### 2. Tests on Percent Conversion

Catalyst loading in exemplar reactions (DMT/TMCD 1:2, 230° C.) was monitored via the elemental Sn content in the precursor mixtures, according to the following equation, where Sn wt. % in the GO-Sn catalyst is adopted from the TGA analysis result (33.4 wt. %).

$$Sn ( ppm ) = \frac{mass of elemental Sn}{mass of monomers and catalyst} \times {10}^{6} = \frac{Sn wt . \% \times mass of catalyst}{mass of DMT + mass of TMCD + mass of catalyst} \times {10}^{6}$$

For example, to get an elemental Sn loading of 200 ppm for a ‘5-gram DMT+7.55 g TMCD’ reaction, the approximated GO-Sn loading is calculated to be 7.5 mg.

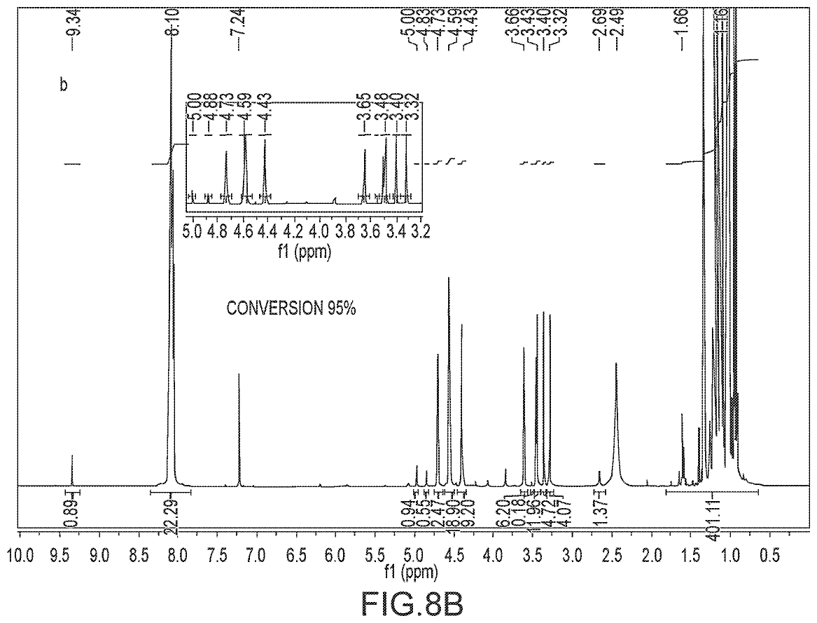

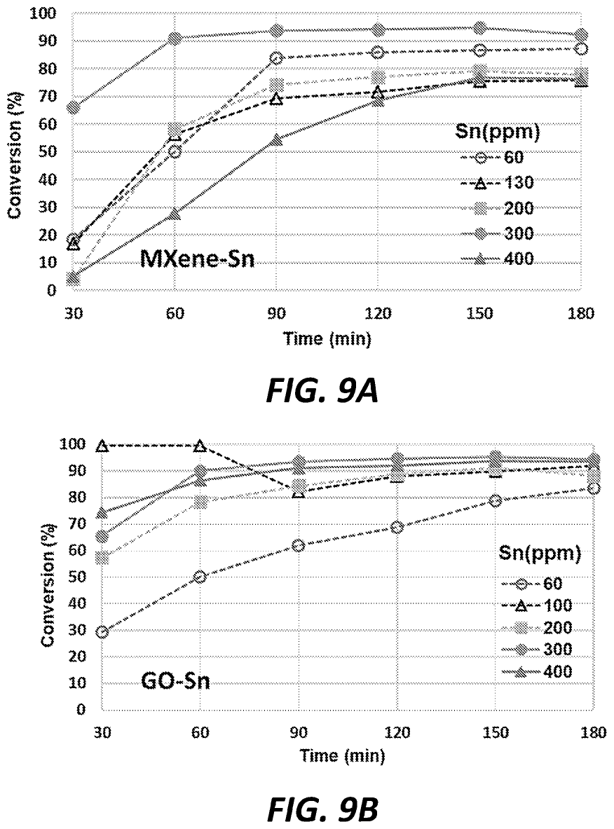

To clarify an effect of catalyst loading on the percent conversion of DMT, FIG. 9A and FIG. 9B present the percent conversion data at different time intervals and Sn loadings. Dependence of DMT percent conversion on catalyst loadings are shown in FIG. 9A for GO-Sn and FIG. 9B for MXene-Sn. Elemental Sn loading ranges from 60 ppm to 400 ppm in both cases, and the DMT % conversion at different time intervals is presented. The two outliers in the 100 ppm-Sn curve (brown) of FIG. 9A was due to experimental error and can be discarded.

Comparing to MXene-Sn catalyst, GO-Sn catalyst exhibits higher catalytic activities in general, superior stability at higher Sn loadings, and noticeably better kinetics, thus is chosen as a primary target for further investigation. More reactions on GO-Sn catalyst at different temperatures have further demonstrated its catalytic activity (FIG. 9A).

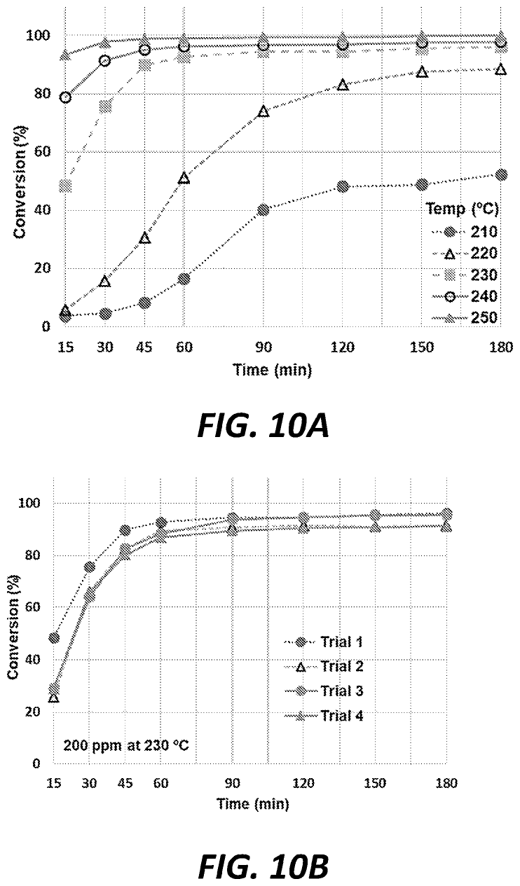

FIG. 10A and FIG. 10B show catalytic behavior of GO-Sn catalyst in exemplar transesterification reactions (DMT:TMCD=1:2, molar ratio) at different reaction temperatures. FIG. 10A shows dependence of DMT percent conversion on reaction time and temperature. FIG. 10B shows percent conversion vs. time curves of four repetitive reactions executed at 200 ppm Sn loading at 230° C., overlapped to demonstrate the reproducibility of the experiments.

The transesterification reaction of DMT and TMCD can be effectively catalyzed by the GO-Sn catalyst, at elemental Sn loadings above 100 ppm, reaction temperature above 230° C., and reaction time over 3 hours (FIG. 9A and FIG. 10A). To set the basis for future kinetics study, four replicates of DMT/TMCD/GO-Sn reactions were executed at 200 ppm Sn loading and 230° C. for 3 hours, to ensure good reproducibility of the presented data (FIG. 10B).

### 3. Activity for Alternative Diol Monomers

Transesterification reactions of DMT with other diols (ethylene glycol (EG), neopentyl glycol (NPG), 2-methyl-1,3-propanediol (MPD), and 1, 4-cyclohexanedimenthanol (CHDM)) were executed at 200 ppm Sn Loading, 230° C. for 3 hours. The DMT percent conversion data are listed for all the reactions in Table 2, as estimated according to the same protocol described with reference to FIG. 8A and FIG. 8B.

TABLE 2
Transesterification Reactions Between DMT and Different
Diols as Catalyzed by GO-Sn Catalyst

| | EG | NPG | MPD | CHDM | TMCD |
|---|---|---|---|---|---|
| DMT (g) | 7.0 | 6.0 | 6.0 | 6.0 | 5.0 |
| Diol | 4.1 ml | 6.44 g | 5.5 ml | 8.9 g | 7.6 g |
| GO-Sn (mg) | 6.9 | 7.4 | 6.9 | 8.9 | 7.9 |
| Methanol (ml) | 0ª | 12 | 0ª | 12 | 15 |
| % Conversion | 59.7% (1^{st} trial) | 96.8% | 98.6% | 97.9% | 94.7% |
| | 52.8% (2^{nd} trial) | | | | |

ªWhen the diol monomer is a liquid at room temperature, no methanol is added in the reaction.

Based on the results in Table 2, GO-Sn catalyst appears to be highly effective for most diol monomers tested, except for EG, which is the least sterically hindered diol substrate. To confirm the result, the reaction was repeated once and similar % conversion of DMT was observed (Table 2, bottom row, second column). We are not yet clear about the origin of this outlier.

### 4. Separability

A motivation to develop heterogeneous catalysts is to explore their separability from reaction products, which can potentially mitigate catalyst-related issues of those products in an industrial setting. Experiments were performed to demonstrate the partial removal of experimental GO-Sn catalyst particles via lab-scale vacuum filtration through a commercial filter membrane (Omnipore™ PTFE membrane, 0.1 μm or 5 μm in pore size). When an appropriate solvent (chloroform, dichloromethane, trichloroethylene, or tetrahydrofuran) is used to dissolve the reaction products, lab-vacuum assisted filtration can run quite smoothly, with an average flow rate of ca. 1 ml/min through a 15-mm diameter filter. In addition, hydrophilic PTFE membranes with average pore sizes of 0.1 μm and 5 μm have both been used in this process, but no prominent differences were observed between the two.

A series of filtration experiments were executed, and the Sn leaching data from ICP-MS analysis are summarized in Table 3. As a control experiment, pure dibutyltin oxide was dissolved in DMT-TMCD/methanol mixture at room temperature at 200 ppm Sn loading, and after filtration, 166.51 ppm of Sn was detected in the filtrate, indicating the partial retention of Sn by the filter membrane (Table 3, the second row). Next, GO-Sn catalyst alone was dispersed in acetone, filtered, and dried, with negligible amount of solid going through the filter with acetone (Table 3, the third row). When GO-Sn was mixed with DMT-TMCD (molar ratio 1:2, methanol added) at room temperature at 200 ppm Sn loading, filtered, and dried, about 38.80 ppm of Sn was detected in the filtrate, demonstrating the stripping of Sn-containing species by experimental monomer mixtures even at room temperature (Table 3, the fourth row). Once the transesterification reactions have occurred at 230° C. for certain time, the Sn leaching drops as reaction time increases and catalyst loading increases (Table 3, row 5˜10), which is opposite to our expectation.

TABLE 3
ICP-MS Analysis on Sn Leaching Through
Filtration of GO-Sn/DMT-TMCD Mixtures.

| | Sn (ppm) | % Sn |
|---|---|---|
| Sample | in Filtrate | Leached |
| Sn(Bu),O/DMT-TMCD, 200 ppm | 166.51 | 83.3% |
| (no reaction, filtered) | | |
| GO-Sn/Acetone (filtered) | 3.26 wt. % | 0.0039% |
| GO-Sn/DMT-TMCD, 200 ppm | 38.80 | 19.4% |
| (no reaction, filtered) | | |
| GO-Sn/DMT-TMCD, 200 ppm 60 min | 41.67 | 20.8% |
| GO-Sn/DMT-TMCD, 200 ppm 120 min | 12.62 | 6.3% |
| GO-Sn/DMT-TMCD, 200 ppm 180 min | 12.49 | 6.2% |
| GO-Sn/DMT-TMCD, 300 ppm 60 min | 16.98 | 5.7% |
| GO-Sn/DMT-TMCD, 300 ppm 120 min | 16.65 | 5.6% |
| GO-Sn/DMT-TMCD, 300 ppm 180 min | 3.92 | 1.3% |

^{a}0.5 g GO-Sn dispersed in acetone was filtered and dried; 0.0002 ± 0.0001 g of solid filtrate was collected
^{b}Estimation based on TGA analysis data: 33.4 wt. % Sn in GO-Sn.
^{c}DMT/TMCD 1:2 ratio

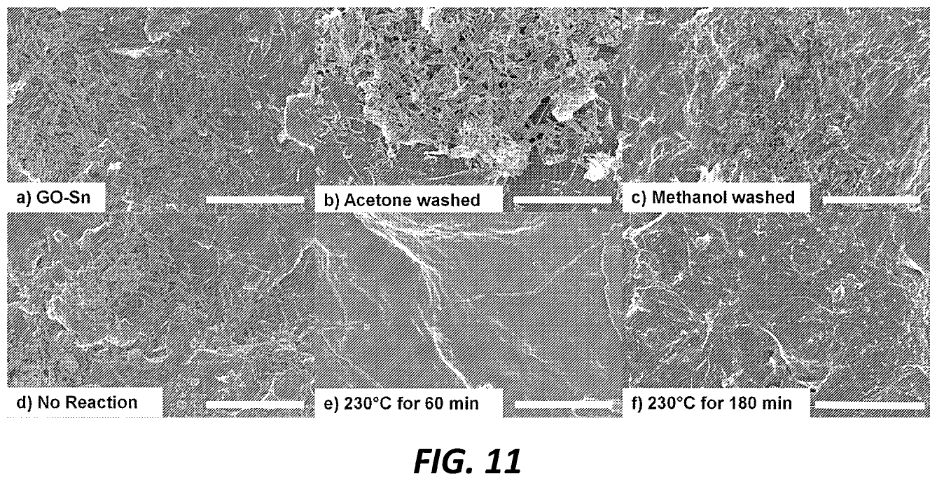

To further clarify the changes occurring to experimental GO-Sn catalyst upon various treatments, SEM images of catalyst samples collected at different scenarios are shown in FIG. 11. FIG. 11 shows SEM images of GO-Sn catalyst samples separated from different treatments: a) as-prepared, b) washed with acetone, c) washed with methanol, d) mixed with DMT-TMCD at room temperature, e) reacted with DMT-TMCD at 230° C. for one hour, and f) reacted with DMT-TMCD at 230° C. for three hours. Scale bars: 5 μm.

The chunky structures on the catalyst surfaces, which were characterized as Sn-rich regions in FIG. 4C and FIG. 4D, alter their morphologies upon solvent washing, disappear upon one hour of transesterification reaction, but seems to reappear as small particles on the surfaces after three hours of reaction. EDX analysis on those imaged surfaces further supported the hypothesis, with Sn wt. % ranges from 16.4% to 42.9% in samples of FIG. 11a-d, varying with the area analyzed, but only 3.2 wt. % in sample of FIG. 11e-f.

Additional SEM and EDX analysis on sample f is needed to further clarify the final allocation of these Sn-rich species. However, the existing data have evidently suggested the presence of physically absorbed Sn-species in GO-Sn, which can be easily detached from sheet surfaces and leached into the oligomer products of DMT-TMCD, even capable of catalyzing transesterification reactions with newly added DMT and TMCD monomers.

In the experiments, the oligomer products of DMT and TMCD after reaction were dissolved in different solvents together with GO-Sn catalyst particles, and pumped through membrane filters, and the filtrates were collected and mixed with fresh DMT and TMCD monomers. In a typical experiment, 6 grams of the filtrate was mixed with 2 grams of DMT and 4 grams of TMCD, and the mixture was kept at 230° C. for 3 hours to allow transesterification reactions to occur. With no new catalyst added, these reactions were run to check if the leached Sn species were catalytically active for the newly added DMT and TMCD monomers. Table 4 lists all the % conversion data of added DMT as analyzed with NMR spectra.

TABLE 4
DMT % Conversion Data of Transesterification Reactions
Run with Different Oligomer Filtrates

| Sample | Acetone | Chloroform | THF |
|---|---|---|---|
| Initial Oligomer Product Before Filtration | 93.6% | 94.6% | 94.6% |
| The Filtrate | 93.7% | 94.4% | 94.8% |
| Filtrate (6 g) + DMT (2 g) + TMCD | 54.7% | 56.3% | 54.3% |
| (4 g) (Room T) | | | |
| Filtrate (6 g) + DMT (2 g) + TMCD (4 g) | 53.5% | 56.4% | 54.7% |
| (0 min at 230° C.) | | | |
| Filtrate (6 g) + DMT (2 g) + TMCD (4 g) | 77.6% | 85.2% | 68.8% |
| (180 min at 230° C.) | | | |
| Calculated % Conversion of Added DMT | 46.8% | 59.2% | 29.9% |

Acetone, chloroform, and tetrahydrofuran (THF) were explored as solvents in the filtration steps. As listed in the last row of Table 4, the percent conversion does show a dependence on the solvent used, with chloroform the highest at ca. 60%, and THF the lowest at ca. 30%. THF is more polar than chloroform (4.0 vs. 2.7), which may indicate that the Sn species can be stripped more by a less polar solvent. Although acetone is more polar than the above two, acetone forms coagulants with the oligomer products, slows down the filtration process significantly, and thus cannot be of a fair comparison here.

### 5. Reusability

Another aspect of the exemplary GO-Sn catalyst is its reusability as a catalyst after being collected from filtration. According to the previous description, Sn-rich species have been partially stripped off from the catalyst surfaces upon the initial transesterification reactions. However, some remnant catalytic activity was observed in the reacted and filtered catalyst samples.

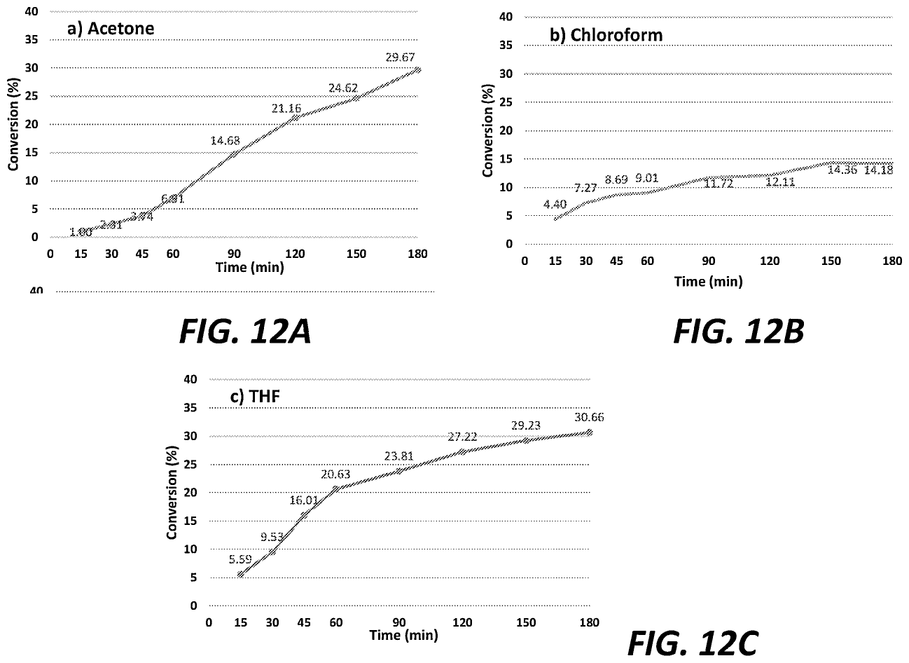

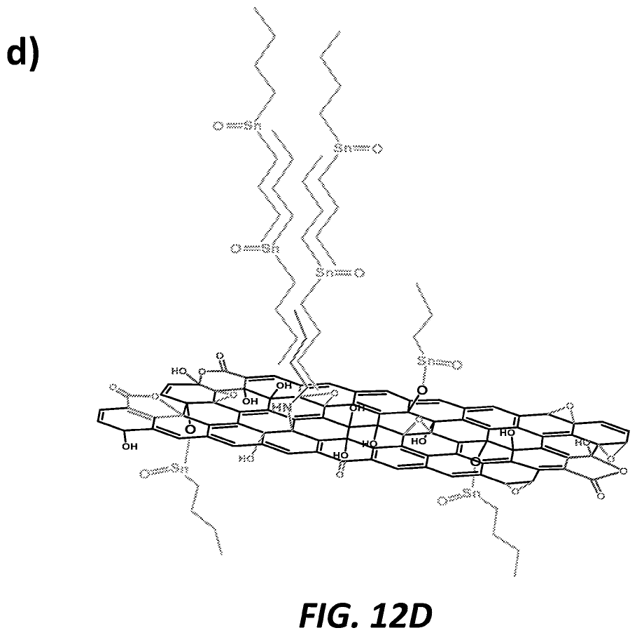

A typical reaction involved mixing 7.1 mg of recycled GO-Sn, 4.77 grams of DMT, 7.09 grams of TMCD, and 15 ml of methanol to achieve a nominal Sn loading of 200 ppm (calculated based on Sn wt. % of 33.4%). The mixture was heated up to 230° C. for 3 hours to allow transesterification reactions to occur. FIG. 12a, b and c show DMT percent conversion versus time curves (reaction kinetics) from GO-Sn recycled with different solvents: (a) acetone, (b) chloroform, and (c) THF. FIG. 12d shows a modified chemical structure model for the experimental GO-Sn catalyst.

In alignment with the Sn-leaching data presented in the previous section, experimental GO-Sn catalyst recycled with THF exhibited the highest activity, while the experimental GO-Sn catalyst recycled with chloroform was the least active. This matches with expectation because chloroform seems to strip the most Sn species off from GO-Sn catalyst. Moreover, because the recycled GO-Sn has a much lower Sn content, elemental Sn loadings in the reusability test runs are actually much lower, probably below 60 ppm as compared to the curves presented in FIG. 9A.

To better explain the observed phenomena so far, we propose a modified chemical structure of the GO-Sn catalyst, as shown in FIG. 12d. In addition to the proposed covalent bonding between Sn and GO in FIG. 1, there might also be some butylamine molecules covalently attached to the GO surface via a covalent C—N bond (shown in green in FIG. 12d), with the short butyl chain pointing out from GO, which renders a self-assembled array of dibutyltin oxide sticking out of the graphitic basal plane via hydrophobic interactions. Because of this weak binding mechanism, these Sn-rich structures can be stripped off upon heating or solvent exposure. Please note, here we only provide a possible explanation for the observed phenomenon, which certainly does not eliminate any other possible explanations.

### EMBODIMENTS

Embodiments of the present disclosure are disclosed in the following clauses.

Embodiment 1. A catalyst, comprising:
a two-dimensional substrate; and
at least one organometallic compound bonded to the two-dimensional substrate, wherein the at least one organometallic compound comprises a carbonyl group.
   Embodiment 2. The catalyst according to Embodiment 1, wherein the two-dimensional substrate comprises graphene oxide.
   Embodiment 3. The catalyst according to Embodiment 1 or Embodiment 2, wherein the organometallic compounds comprise organotin compounds.
   Embodiment 4. The catalyst according to Embodiment 3, wherein the organotin compounds comprise dibutyltin oxide (Sn(C₄H₉)₂O).
   Embodiment 5. The catalyst according to any one of Embodiments 1-4, wherein the organometallic compounds are physically attached to the two-dimensional substrate.
   Embodiment 6. The catalyst according to any one of Embodiments 1-5, wherein the catalyst comprises about 15 wt % to about 30 wt % organometallic compounds.
   Embodiment 7. The catalyst according to any one of Embodiments 1-6, wherein the catalyst has a BET surface area of about 5 m²/g to about 6 m²/g.
   Embodiment 8. A method of preparing a polymer product, the method comprising:
combining a catalyst with an alcohol and an ester in a solvent, thereby generating a mixture;
   the catalyst comprising a two-dimensional substrate and organometallic compounds, wherein each organometallic compound comprises a carbonyl group and is bonded to the two-dimensional substrate; and obtaining the polymer product from the mixture.
      Embodiment 9. The method according to Embodiment 8, further comprising separating the catalyst from the mixture.
      Embodiment 10. The method according to Embodiment 9, wherein separating the catalyst includes using membrane filtration or vacuum filtration.
      Embodiment 11. The method according to Embodiment 9 or Embodiment 10, further comprising reusing the separated catalyst.
      Embodiment 12. The method according to any one of Embodiments 8-11, wherein the alcohol is a diol;
wherein the organometallic compounds are organotin compounds; and
wherein the solvent comprises methanol.
   Embodiment 13. The method according to any one of Embodiments 8-12, wherein the wherein the two-dimensional substrate is graphene oxide; and wherein the organometallic compounds are dibutyltin oxide (Sn(C₄H₉)₂O).
   Embodiment 14. The method according to any one of Embodiments 8-13, wherein the alcohol is 2, 2, 4, 4-tetramethyl-1,3-cyclobutanediol (TMCD), ethylene glycol, neopentyl glycol, 2-methyl-1,3-propanediol, or 1, 4-cyclohexanedimenthanol.
   Embodiment 15. The method according to any one of Embodiments 8-14, wherein the ester is dimethyl terephthalate (DMT).
   Embodiment 16. The method according to any one of Embodiments 8-15, further comprising heating the mixture to about 220° C. to about 250° C. for about 60 minutes to about 180 minutes.
   Embodiment 17. A method of making a catalyst, the method comprising:
combining a two-dimensional substrate, a first organic solvent, and a deprotonation reagent to form a mixture;
adding an organometallic compound to the mixture;
reacting the mixture with the organometallic compound for a predetermined period of time;
combining the mixture and a second organic solvent; and
filtering the mixture with the second organic solvent.
   Embodiment 18. The method according to Embodiment 17, further comprising, before adding the deprotonation reagent, purging the mixture with an inert gas;
stirring the mixture; and
after adding the deprotonation reagent, heating the mixture, wherein the deprotonation reagent comprises butylamine (C₄H₁₁N).
   Embodiment 19. The method according to Embodiment 17 or Embodiment 18, further comprising:
washing a retentate; and
drying the retentate,
wherein the first organic solvent comprises toluene;
wherein the inert gas comprises nitrogen (N₂);
wherein the second organic solvent comprises acetone;
wherein stirring the mixture in a reaction vessel further comprises purging the reaction vessel with the inert gas; and
wherein reacting the mixture with the organometallic compound comprises heating the mixture.
   Embodiment 20. The method according to any one of Embodiments 17-19, wherein the organometallic compound is dibutyltin oxide (Sn(C₄H₉)₂O); and
wherein the wherein the two-dimensional substrate comprises graphene oxide.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

What is claimed is:

1. A catalyst, comprising:
a two-dimensional substrate; and
at least one organometallic compound bonded to the two-dimensional substrate,
wherein the at least one organometallic compound comprises a carbonyl group.

2. The catalyst according to claim 1, wherein the two-dimensional substrate comprises graphene oxide.

3. The catalyst according to claim 1, wherein the organometallic compounds comprise organotin compounds.

4. The catalyst according to claim 3, wherein the organotin compounds comprise dibutyltin oxide (Sn(C₄H₉)₂O).

5. The catalyst according to claim 1, wherein the catalyst comprises about 15 wt % to about 30 wt % at least one organometallic compound.

6. The catalyst according to claim 1, wherein the at least one organometallic compounds are physically attached to the two-dimensional substrate.

7. The catalyst according to claim 1, wherein the catalyst has a BET surface area of about 5 m²/g to about 6 m²/g.

8. A method of preparing a polymer product, the method comprising:
combining a catalyst with an alcohol and an ester in a solvent, thereby generating a mixture;
the catalyst comprising a two-dimensional substrate and organometallic compounds, wherein each organometallic compound comprises a carbonyl group and is bonded to the two-dimensional substrate; and
obtaining the polymer product from the mixture.

9. The method according to claim 8, further comprising separating the catalyst from the mixture.

10. The method according to claim 9, wherein separating the catalyst includes using membrane filtration or vacuum filtration.

11. The method according to claim 9, further comprising reusing the separated catalyst.

12. The method according to claim 8, wherein the alcohol is a diol;
wherein the organometallic compounds are organotin compounds; and
wherein the solvent comprises methanol.

13. The method according to claim 12, wherein the wherein the two-dimensional substrate is graphene oxide; and
wherein the organometallic compounds are dibutyltin oxide (Sn(C₄H₉)₂O).

14. The method according to claim 8, wherein the alcohol is 2, 2, 4, 4-tetramethyl-1,3-cyclobutanediol (TMCD), ethylene glycol, neopentyl glycol, 2-methyl-1,3-propanediol, or 1, 4-cyclohexanedimenthanol.

15. The method according to claim 8, wherein the ester is dimethyl terephthalate (DMT).

16. The method according to claim 8, further comprising heating the mixture to about 220° C. to about 250° C. for about 60 minutes to about 180 minutes.

17. A method of making a catalyst, the method comprising:
combining a two-dimensional substrate, a first organic solvent, and a deprotonation reagent to form a mixture;
adding an organometallic compound to the mixture;
reacting the mixture with the organometallic compound for a predetermined period of time;
combining the mixture and a second organic solvent; and
filtering the mixture with the second organic solvent.

18. The method according to claim 17, further comprising, before adding the deprotonation reagent, purging the mixture with an inert gas;
stirring the mixture; and
after adding the deprotonation reagent, heating the mixture, wherein the deprotonation reagent comprises butylamine (C₄H₁₁N).

19. The method according to claim 18, further comprising:
washing a retentate; and
drying the retentate,
wherein the first organic solvent comprises toluene;
wherein the inert gas comprises nitrogen (N₂);
wherein the second organic solvent comprises acetone;
wherein stirring the mixture in a reaction vessel further comprises purging the reaction vessel with the inert gas; and
wherein reacting the mixture with the organometallic compound comprises heating the mixture.

20. The method according to claim 19, wherein the organometallic compound is dibutyltin oxide (Sn(C₄H₉)₂O); and
wherein the wherein the two-dimensional substrate comprises graphene oxide.
